(19) United States
(12) Patent Application Publication
(10) Pub. No.: US 2018/0068222 A1
(43) Pub. Date: Mar. 8, 2018

(54) System and Method of Advising Human Verification of Machine-Annotated Ground Truth - Low Entropy Focus

(71) Applicant: International Business Machines Corporation, Armonk, NY (US)

(72) Inventors: Paul E. Brennan, Dublin (IE); Scott R. Carrier, Apex, NC (US); Michael L. Stickler, Columbus, OH (US)

(21) Appl. No.: 15/258,298

(22) Filed: Sep. 7, 2016

(51) Int. Cl. G06N 5/02; G06N 99/00

(52) U.S. Cl. CPC G06N 5/022; G06N 99/005

(57) ABSTRACT

A method, system and a computer program product are provided for verifying ground truth data by iteratively assigning machine-annotated training set examples to clusters which are prioritized based on verification scores to identify and display one or more prioritized review candidate training set examples grouped in a prioritized cluster in order to solicit verification or correction feedback from a human subject matter expert for inclusion in an accepted training set.

### BACKGROUND OF THE INVENTION

In the field of artificially intelligent computer systems capable of answering questions posed in natural language, cognitive question answering (QA) systems (such as the IBM Watson™ artificially intelligent computer system or and other natural language question answering systems) process questions posed in natural language to determine answers and associated confidence scores based on knowledge acquired by the QA system. To train such QA systems, a subject matter expert (SME) presents ground truth data in the form of question-answer-passage (QAP) triplets or answer keys to a machine learning algorithm. Typically derived from fact statements submissions to the QA system, such ground truth data is expensive and difficult to collect. Conventional approaches for developing ground truth (GT) will use an annotator component to identify entities and entity relationships according to a statistical model that is based on ground truth. Such annotator components are created by training a machine-learning annotator with training data and then validating the annotator by evaluating training data with test data and blind data, but such approaches are time-consuming, error-prone, and labor-intensive. Even when the process is expedited by using dictionary and rule-based annotators to pre-annotate the ground truth, SMEs must still review and correct the entity/relation classification instances in the machine-annotated ground truth. With hundreds or thousands of entity/relation instances to review in the machine-annotated ground truth, the accuracy of the SME's validation work can be impaired due to fatigue or sloppiness as the SME skims through too quickly to accurately complete the task. As a result, the existing solutions for efficiently generating and validating ground truth data are extremely difficult at a practical level.

### SUMMARY

Broadly speaking, selected embodiments of the present disclosure provide a ground truth verification system, method, and apparatus for generating ground truth for a machine-learning process by machine-annotating a ground truth training set and validation set to identify annotation instances (e.g., entities and relationships) characterized with a relatively low entropy measure, assigning such annotation instances to groups or clusters based on feature similarity, and generating a verification score for each annotation cluster of how likely the annotations in a given cluster are to be true-positives or otherwise meriting SME review for verification or correction. By computing the cluster verification scores from predetermined scoring criteria inputs collected from one or more human annotators on the SME team, the annotation clusters may be prioritized in real time for human annotator or SME verification, either individually or in bulk, thereby further honing ground truth accuracy. In selected embodiments, the verification scores may be based on a probability or confidence metric which quantifies the likelihood that annotations in a cluster are “true positives” based on the training model for the feature set of a given annotation cluster, with lower confidence metric scores being weighted to produce a higher verification score ranking indicating a need for human verification. In other embodiments, the verification score may be based on an SME consistency (or inconsistency) metric which quantities and compares the verification performance of the reviewing subject matter expert (SME) and other SMEs who have verified annotation instances within the same cluster, such as by using inter annotator agreement (IAA) scores for the entity/relations behind a given annotation cluster. In other embodiments, the verification score may be based on a comparative measure of the cluster sizes, with larger clusters being weighted more heavily for higher ranking. In other embodiments, the verification score may be based on cross-validation accuracy scores for each annotation in a cluster, such as Recall/Precision/F1(R/P/F1) metric values, which quantify just how similar the features are for that particular annotation type, with clusters having annotation instances that are more similar to one another being weighted more heavily for higher ranking since SMEs may only need to review a few instances of an annotation to verify the cluster. In selected embodiments, the ground truth verification system may be implemented with a browser-based ground truth verification interface which provides a cluster view of entity and/or relationship mentions from the training and validation sets, where each entity/relationship cluster is prioritized for display on the basis of the verification scores. In addition or in the alternative, the browser-based ground truth verification interface may be configured to make verification suggestions to a user, such as a subject matter expert, for each entity/relationship mention in the cluster by identifying training examples that can be accepted or rejected as a cluster group. By presenting clustered verification suggestions, the user can quickly and efficiently identify training examples that can be verified or rejected as a batch. The browser-based ground truth verification interface may also be configured to provide the user with the option to accept or reject individual entity/relationship mentions, click on a mention to see the entire document, and/or leave the training set as is. In this way, information assembled in the browser-based ground truth verification interface may be used by a domain expert or system knowledge expert to verify or correct entity/relationship mentions more quickly, thus expediting the veracity of the ground truth.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a system diagram that includes a QA system connected in a network environment to a computing system that uses a ground truth verification engine to verify or correct machine-annotated ground truth data;

FIG. 2 is a block diagram of a processor and components of an information handling system such as those shown in FIG. 1;

FIG. 3 illustrates a simplified flow chart showing the logic for verifying low entropy entity/relationship instances in clusters of machine-annotated ground truth data for use in training an annotator used by a QA system; and

FIG. 4 illustrates a ground truth verification interface display with a clustered view of entity and/or relationship mentions from training and validation sets.

### DETAILED DESCRIPTION

The present invention may be a system, a method, and/or a computer program product. In addition, selected aspects of the present invention may take the form of an entirely hardware embodiment, an entirely software embodiment (including firmware, resident software, micro-code, etc.), or an embodiment combining software and/or hardware aspects that may all generally be referred to herein as a “circuit,” “module” or “system” Furthermore, aspects of the present invention may take the form of computer program product embodied in a computer readable storage medium or media having computer readable program instructions thereon for causing a processor to carry out aspects of the present invention. Thus embodied, the disclosed system, a method, and/or a computer program product is operative to improve the functionality and operation of a cognitive question answering (QA) systems by efficiently providing ground truth data for improved training and evaluation of cognitive QA systems.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a Public Switched Circuit Network (PSTN), a packet-based network, a personal area network (PAN), a local area network (LAN), a wide area network (WAN), a wireless network, or any suitable combination thereof. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language, Hypertext Precursor (PHP), or similar programming languages. The computer readable program instructions may execute entirely on the user's computer, partly on the user's computer, as a stand-alone software package, partly on the user's computer and partly on a remote computer or entirely on the remote computer or server or cluster of servers. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a sub-system, module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

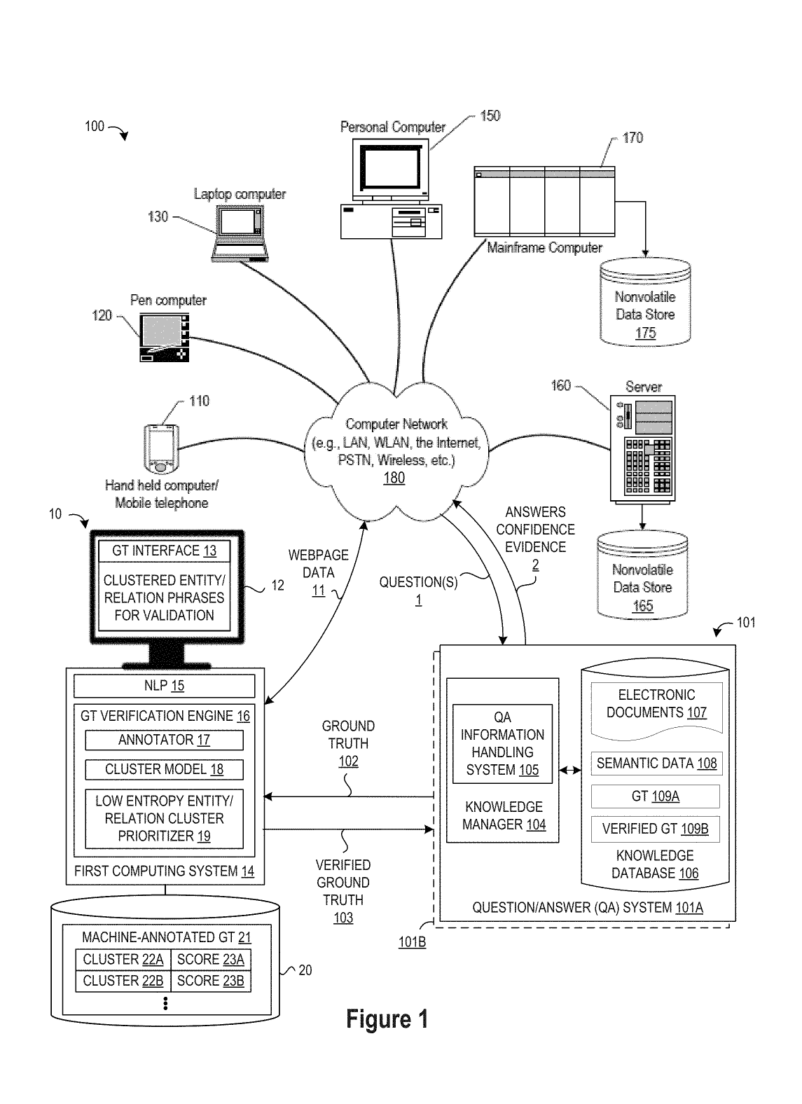

FIG. 1 depicts a schematic diagram 100 of one illustrative embodiment of a question/answer (QA) system 101 directly or indirectly connected to a first computing system 14 that uses a ground truth verification engine 16 to verify or correct machine-annotated ground truth data 102 (e.g., entity and relationship instances in training sets) for training and evaluation of the QA system 101. The QA system 101 may include one or more QA system pipelines 101A, 10113, each of which includes a knowledge manager computing device 104 (comprising one or more processors and one or more memories, and potentially any other computing device elements generally known in the art including buses, storage devices, communication interfaces, and the like) for processing questions received over the network 180 from one or more users at computing devices (e.g., 110, 120, 130). Over the network 180, the computing devices communicate with each other and with other devices or components via one or more wired and/or wireless data communication links, where each communication link may comprise one or more of wires, routers, switches, transmitters, receivers, or the like. In this networked arrangement, the QA system 101 and network 180 may enable question/answer (QA) generation functionality for one or more content users. Other embodiments of QA system 101 may be used with components, systems, sub-systems, and/or devices other than those that are depicted herein.

In the QA system 101, the knowledge manager 104 may be configured to receive inputs from various sources. For example, knowledge manager 104 may receive input from the network 180, one or more knowledge bases or corpora 106 of electronic documents 107, semantic data 108, or other data, content users, and other possible sources of input. In selected embodiments, the knowledge base 106 may include structured, semi-structured, and/or unstructured content in a plurality of documents that are contained in one or more large knowledge databases or corpora. The various computing devices (e.g., 110, 120, 130) on the network 180 may include access points for content creators and content users. Some of the computing devices may include devices for a database storing the corpus of data as the body of information used by the knowledge manager 104 to generate answers to cases. The network 180 may include local network connections and remote connections in various embodiments, such that knowledge manager 104 may operate in environments of any size, including local networks (e.g., LAN) and global networks (e.g., the Internet). Additionally, knowledge manager 104 serves as a front-end system that can make available a variety of knowledge extracted from or represented in documents, network-accessible sources and/or structured data sources. In this manner, some processes populate the knowledge manager which may include input interfaces to receive knowledge requests and respond accordingly.

In one embodiment, the content creator creates content in an electronic document 107 for use as part of a corpora 106 of data with knowledge manager 104. The corpora 106 may include any structured and unstructured documents, including but not limited to any file, text, article, or source of data (e.g., scholarly articles, dictionary definitions, encyclopedia references, and the like) for use by the knowledge manager 104. Content users may access the knowledge manager 104 via a connection or an Internet connection to the network 180, and may input questions to the knowledge manager 104 that may be answered by the content in the corpus of data.

As further described below, when a process evaluates a given section of a document for semantic content, the process can use a variety of conventions to query it from the knowledge manager. One convention is to send a well-formed question 1. Semantic content is content based on the relation between signifiers, such as words, phrases, signs, and symbols, and what they stand for, their denotation, or connotation. In other words, semantic content is content that interprets an expression, such as by using Natural Language (NL) Processing. In one embodiment, the process sends well-formed questions 1 (e.g., natural language questions, etc.) to the knowledge manager 104. Knowledge manager 104 may interpret the question and provide a response to the content user containing one or more answers 2 to the question 1. In some embodiments, the knowledge manager 104 may provide a response to users in a ranked list of answers 2.

In some illustrative embodiments, QA system 101 may be the IBM Watson™ QA system available from International Business Machines Corporation of Armonk, N.Y., which is augmented with the mechanisms of the illustrative embodiments described hereafter. The IBM Watson™ knowledge manager system may receive an input question 1 which it then parses to extract the major features of the question, that in turn are then used to formulate queries that are applied to the corpus of data stored in the knowledge base 106. Based on the application of the queries to the corpus of data, a set of hypotheses, or candidate answers to the input question, are generated by looking across the corpus of data for portions of the corpus of data that have some potential for containing a valuable response to the input question.

In particular, a received question 1 may be processed by the IBM Watson™ QA system 101 which performs deep analysis on the language of the input question 1 and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e., candidate answer, is inferred by the question. This process may be repeated for each of the candidate answers until the IBM Watson™ QA system identifies candidate answers that surface as being significantly stronger than others and thus, generates a final answer, or ranked set of answers, for the input question. The QA system 101 then generates an output response or answer 2 with the final answer and associated confidence and supporting evidence. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

In addition to providing answers to questions, QA system 101 is connected to at least a first computing system 14 having a connected display 12 and memory or database storage 20 for retrieving ground truth data 102 which is processed with a classifier or annotator 17 to generate machine-annotated ground truth 21 having clusters 22 of training sets and/or validation sets, each of which has a corresponding validation score 23 for use in prioritizing SME verification and correction to generate verified ground truth 103 which may be stored in the knowledge database 106 as verified GT 109B for use in training the QA system 101. Though shown as being directly connected to the QA system 101, the first computing system 14 may be indirectly connected to the QA system 101 via the computer network 180. Alternatively, the functionality described herein with reference to the first computing system 14 may be embodied in or integrated with the QA system 101.

In various embodiments, the QA system 101 is implemented to receive a variety of data from various computing devices (e.g., 110, 120, 130, 140, 150, 160, 170) and/or other data sources, which in turn is used to perform QA operations described in greater detail herein. In certain embodiments, the QA system 101 may receive a first set of information from a first computing device (e.g., laptop computer 130) which is used to perform QA processing operations resulting in the generation of a second set of data, which in turn is provided to a second computing device (e.g., server 160). In response, the second computing device may process the second set of data to generate a third set of data, which is then provided back to the QA system 101. In turn, the QA system 101 may perform additional QA processing operations on the third set of data to generate a fourth set of data, which is then provided to the first computing device (e.g., 130). In various embodiments the exchange of data between various computing devices (e.g., 101, 110, 120, 130, 140, 150, 160, 170) results in more efficient processing of data as each of the computing devices can be optimized for the types of data it processes. Likewise, the most appropriate data for a particular purpose can be sourced from the most suitable computing device (e.g., 110, 120, 130, 140, 150, 160, 170) or data source, thereby increasing processing efficiency. Skilled practitioners of the art will realize that many such embodiments are possible and that the foregoing is not intended to limit the spirit, scope or intent of the invention.

To train the QA system 101, the first computing system 14 may be configured to collect, generate, and store machine-annotated ground truth data 21 (e.g., as training sets and/or validation sets) having annotation instances which are clustered by feature similarity into clusters 22A, 22B for storage in the memory/database storage 20, alone or in combination with associated verification scores for each cluster 23A, 23B. To efficiently collect the machine-annotated ground truth data 21, the first computing system 14 may be configured to access and retrieve ground truth data 109A that is stored at the knowledge database 106. In addition or in the alternative, the first computing system 14 may be configured to access one or more websites using search engine functionality or other network navigation tool to access one or more remote websites over the network 180 in order to locate information (e.g., an answer to a question). In selected embodiments, the search engine functionality or other network navigation tool may be embodied as part of a ground truth verification engine 16 which exchanges webpage data 11 using any desired Internet transfer protocols for accessing and retrieving webpage data, such as HTTP or the like. At an accessed website, the user may identify around truth data that should be collected for addition to a specified corpus, such as an answer to a pending question, or a document (or document link) that should be added to the corpus.

Once retrieved, portions of the ground truth 102 may be identified and processed by the annotator 17 to generate machine-annotated ground truth 21. To this end, the ground truth verification engine 16 may be configured with a machine annotator 17, such as dictionary/rules-based annotator or a machine-learned annotator from a small human-curated training set, which uses one or more knowledge resources to classify the document text passages from the retrieved ground truth to identify entity and relationship annotations in one or more training sets and validation sets. Once the machine-annotated training and validation sets are available (or retrieved from storage 20), they may be scanned to generate a vector representation for each machine-annotated training and validation sets using any suitable technique, such as using an extended version of Word2Vec, Doc2Vec, or similar tools, to convert phrases to vectors, and applying a cluster modeling program 18 to cluster the vectors from the training and validation sets. To this end, the ground truth verification engine 16 may be configured with a suitable neural network model (not shown) to generate vector representations of the phrases in the machine-annotated ground truth 21, and may also be configured with a cluster modeling program 18 to output clusters as groups of phrases with similar meanings, effectively placing words and phrases with similar meanings close to each other (e.g., in a Euclidean space).

To identify portions of the machine-annotated ground truth 21 that would most benefit from human verification, the ground truth verification engine 16 is configured with a cluster prioritizer 19 which prioritizes clusters of phrases containing machine-annotated entities/relationships for the purposes of batch verification from a human SME. To exploit the efficiency from verifying larger clusters which contribute more to the training set size, the prioritizer 19 may prioritize clusters based on cluster size so that training examples in large clusters are given priority for SME review. In addition or in the alternative, the prioritizer 19 may prioritize clusters based on a confidence measure which the statistical probability that the machine-annotated training examples in the cluster are “true positives” based on the feature set of each annotation cluster. In addition or in the alternative, the prioritizer 19 may prioritize clusters based on a consistency measure (e.g., IAA score) for the reviewing SME as compared to other SMEs reviewing entity/relationships in each annotation cluster. In addition or in the alternative, the prioritizer 19 may prioritize clusters based on a cross-validation R/P/F1 metric for the entity/relationship instances in a given annotation cluster.

To visually present the clusters for SME review, the ground truth verification engine 16 is configured to display a ground truth (GT) interface 13 on the connected display 12. At the GT interface 13, the user at the first computing system 14 can manipulate a cursor or otherwise interact with a displayed listing of clustered entity/relation phrases that are prioritized and flagged for SME validation to verify or correct prioritized training examples in clusters needing human verification. In selected embodiments, the displayed cluster of entity/relation phrases is selected on the basis of a verification score for the cluster, with each constituent entity/relation phrase from the cluster being displayed for SME review. Verification or correction information assembled in the ground truth interface window 13 based on input from the domain expert or system knowledge expert may be used to store and/or send verified ground truth data 103 for storage in the knowledge database 106 as stored ground truth data 109B for use in training a final classifier or annotator.

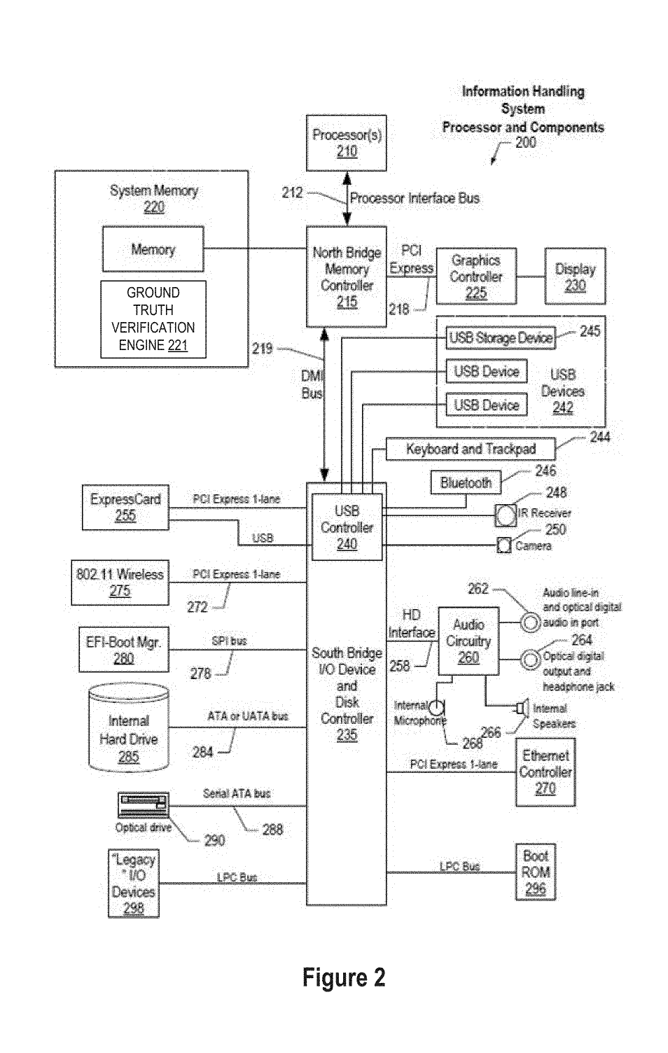

Types of information handling systems that can utilize QA system 101 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, server 160, and mainframe computer 170. As shown, the various information handling systems can be networked together using computer network 180. Types of computer network 180 that can be used to interconnect the various information handling systems include Personal Area Networks (PANs), Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems may use separate nonvolatile data stores. For example, server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. In the system memory 220, a variety of programs may be stored in one or more memory device, including a ground truth verification engine module 221 which may be invoked to process machine-annotated ground truth training set and validation set data to identify entities and relationships characterized with a relatively low entropy measure which are assigned or grouped into clusters using a rule-based probabilistic algorithm so that entity/relationship phrases (e.g., in training examples) that are clustered with other entity/relationship phrases (e.g., in validation examples) on the basis of meeting one or more feature selection criteria may be identified, prioritized, and highlighted as review candidates for a human annotator or SME to verify, either individually or in bulk, thereby generating verified ground truth for use in training and evaluating a computing system (e.g., an IBM Watson™ QA system). Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. Other components often included in Southbridge. 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, moderns, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etc.

Wireless Local Area Network (LAN) device 275 connects to Southbridge 235 via the PCI or PCI Express bus 272. LAN device 275 typically implements one of the IEEE 802.11 standards for over-the-air modulation techniques to wireless communicate between information handling system 200 and another computer system or device. Extensible Firmware Interface (EFI) manager 280 connects to Southbridge 235 via Serial Peripheral Interface (SPI) bus 278 and is used to interface between an operating system and platform firmware. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaining device, ATM machine, a portable telephone device, a communication device or other devices that include a processor and memory. In addition, an information handling system need not necessarily embody the north bridge/south bridge controller architecture, as it will be appreciated that other architectures may also be employed.

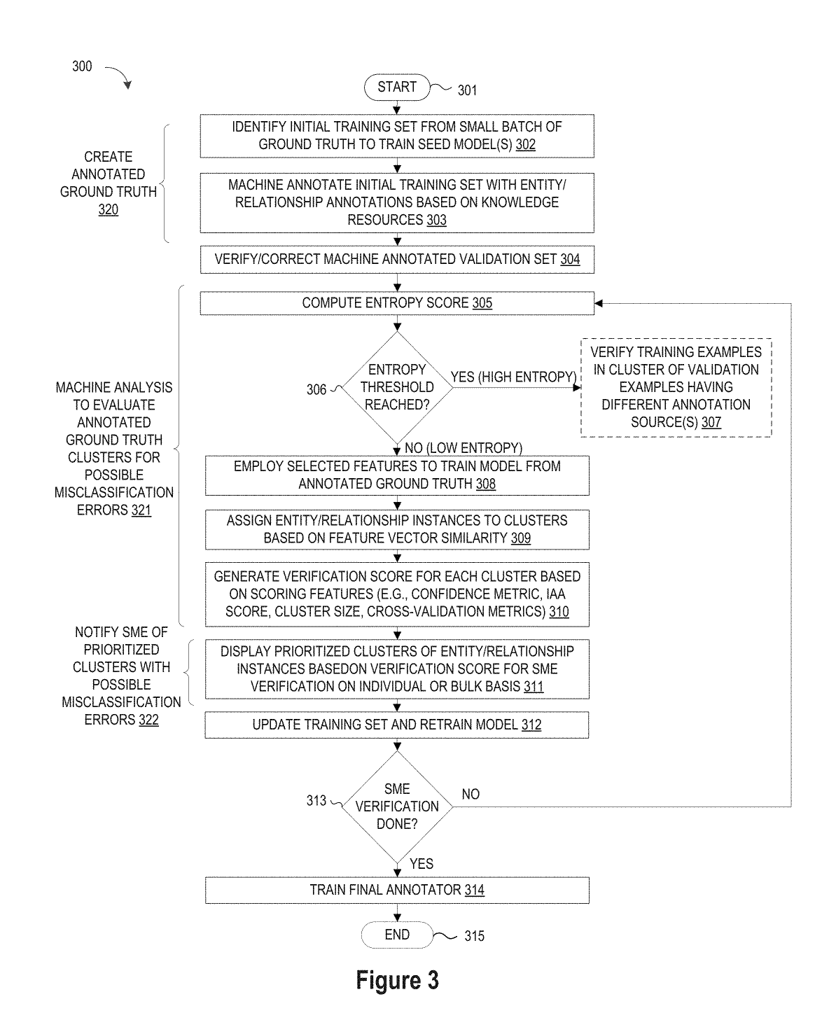

FIG. 3 depicts an approach that can be executed on an information handling system to verify and/or correct ground truth data having low entropy entity/relationship instances for use in training an annotator in a QA system, such as QA system 101 shown in FIG. 1. This approach can be implemented at the computing system 14 or the QA system 101 shown in FIG. 1, or may be implemented as a separate computing system, method, or module. Wherever implemented, the disclosed ground truth verification scheme efficiently clusters entity/relationship instances from a machine-annotated ground truth for batch verification to maximize the use of SME time by prioritizing clusters “on the go” with verification score inputs from one or more SMEs to further hone the accuracy in flagging clusters for human verification using a browser-based ground truth verification interface window to efficiently verify, add or remove, either individually or in bulk (e.g., by cluster). The ground truth verification processing may include displaying a browser interface which provides a cluster view of entity and/or relationship mentions from the machine-annotated training and validations sets, where each cluster of entity/relationship mentions is ranked on the basis of cluster verification scores which are derived from scoring inputs from a team of SMEs verifying the machine-annotated ground truth to enhance suspected error detection. In addition or in the alternative, the browser interface may display verification suggestions to a user, such as a subject matter expert, by identifying training examples most likely to be misclassified or mislabeled, grouped by cluster. By presenting clustered verification suggestions, the user can quickly and efficiently identify training examples that are very likely false positives or negatives. With the disclosed ground truth verification scheme, an information handling system can be configured to collect and verify ground truth data in the form of QA pairs and associated source passages for use in training the QA system.

To provide additional details for an improved understanding of selected embodiments of the present disclosure, reference is now made to FIG. 3 which depicts a simplified flow chart 300 showing the logic for verifying low entropy entity/relationship instances in clusters of machine-annotated ground truth data for use in training an annotator used by a QA system. The processing shown in FIG. 3 may be performed by a cognitive system, such as the first computing system 14, QA system 101, or other natural language question answering system. Wherever implemented, the disclosed ground truth verification scheme processes machine-annotated a ground truth training set and validation set to identify, cluster, and prioritize entity/relationship instances characterized with a relatively low entropy measure to identify clustered training examples that meet one or more feature selection criteria and to score the clustered training examples using verification scores to rank and prioritize each cluster of training examples as review candidates for a human annotator or SME to verify, either individually or in bulk.

FIG. 3 processing commences at 301 whereupon, at step 320, machine-annotated training sets and validations sets are created using a machine annotator with at least a preliminary verification or correction by a human SME. In selected embodiments, the processing at step 320 starts with an initial human-curated training set that is identified (at step 302) from a small batch of ground truth for use in training one or more seed models. For example, this seed model can be sourced from the ground truth that is curated from SMEs while drafting the ground truth guidelines. The identified initial training set and validation set are then run through a machine annotator (at step 303) which parses the input text sentences to find entity parts of speech and their associated relationship instances in the sentence. To assist with the machine annotation at step 303, one or more knowledge resources may be retrieved, such as ontologies, semantic networks, or other types of knowledge bases that are generic or specific to a particular domain of the received document or the corpus from which the document was received. In addition, it will be appreciated that any suitable machine-annotator could be employed at step 303, such as dictionary-based machine-annotator, rule-based machine-annotator, and machine learning annotator, or the like.

As a result of step 303, the initial training and validation sets are annotated with entity and relationship annotations based on the information contained in the knowledge resources. At step 304, the machine-annotated validation set may be reviewed by a human SME to verify or correct any mistakes in the machine-annotated validation set to confirm that they are labeled correctly. In selected embodiments, the initial creation of the machine-annotated training and validation sets at step 320 may be performed at a computing system, such as the QA system 101, first computing system 14, or other NLP question answering system which uses a dictionary or rule-based classifier (e.g., annotator 17) or other suitable named entity recognition classifier to pre-annotate the training and validation sets (at step 303), and then uses a human SME to correct any mistakes or otherwise verify the pre-annotated validation set (at step 304). As will be appreciated, the machine annotator processes a given input sentence statement to locate and classify named entities in the text into pre-defined categories, such as the names of persons, organizations, locations, expressions of times, quantities, monetary values, percentages, etc. As described herein, a Natural Language Processing (NLP) routine may be used to parse the input sentence and/or identify potential named entities and relationship patterns, where “NLP” refers to the field of computer science, artificial intelligence, and linguistics concerned with the interactions between computers and human (natural) languages. In this context, NLP is related to the area of human-computer interaction and natural language understanding by computer systems that enable computer systems to derive meaning from human or natural language input.

At step 321, the ground truth verification method proceeds to apply machine analysis to evaluate the annotated training set clusters for possible classification errors. The processing at step 321 may be performed at a cognitive system, such as the QA system 101, first computing system 14, or other NLP question answering system having a cluster model (e.g., 18) and prioritizer (e.g., 19), that can be configured to assign training set entity/relationship annotations characterized with a relatively low entropy measure into clusters and to identify and prioritize clusters of candidate training example review candidates on the basis of verification scores that are computed from one or more scoring features.

In selected embodiments, the evaluation of the training set annotations at step 321 may begin with an entropy score computation step 305 wherein a probability-based measure of the amount of uncertainty in the machine-annotated training and validation sets is using any suitable entropy calculation technique. In accordance with selected embodiments, the entropy score is computed as H(xₛ)=−Σᵢ₌₁^{m}p(xₛᵢ)log_{b}p(xₛᵢ), where H(xₛ) stands for the entropy, where the minus sign is used to create a positive value for the entropy, where p(xₛᵢ) is the probability of an event, and where the logarithm term is used to make more compact and efficient decision trees calculation. When starting out in the beginning with a small sampling of annotated ground truth, the computed entropy score for a given entity or relationship will likely be especially volatile, but should level off over time as the iterative process is repeated and more training set annotations are verified and used to update the training set.

If the computed entropy scores for the machine-annotated training/validation sets are above (e.g., meet or exceed) a predetermined entropy threshold (affirmative outcome to detection step 306), this indicates that the high entropy machine-annotated entity/relationship instances may be processed separately at step 307, such as by verifying training examples that are clustered with validation examples have different annotation sources. (As indicated with the dashed lines at step 307, this step may optionally be skipped.) However, if the computed entropy scores are below the predetermined entropy threshold (negative outcome to detection step 306), this indicates that the machine-annotated entity/relationship instances have a low degree of uncertainty (low entropy).

In the case of low entropy machine-annotated ground truth, the processing at step 308 may employ feature selection algorithms as part of the machine analysis to train a model from the machine annotated entity/relationship instances. In selected embodiments, the analysis of the machine-annotated training and validation sets may involve scanning the machine-annotated entity/relationship phrases to generate a vector representation for each machine-annotated training and validation set using any suitable technique, such as an extended version of Word2Vec, Doc2Vec, or similar tools, to convert phrases to vectors. In addition, the feature selection algorithms used at step 308 may be implemented to determine which features are most indicative of a “true positive” for an entity or relationship and to appropriately weigh such features.

At step 309, the vector representations of the machine-annotated training and validation sets are assigned to clusters based on feature similarity, such as by using a rule-based probabilistic algorithm that is suitable for clustering low entropy machine-annotated entity/relationship instances. In selected embodiments, the cluster processing at step 309 may be performed at a cognitive system, such as the QA system 101, first computing system 14, or other NLP question answering system, such as by applying the cluster model 18 (FIG. 1) to perform sentence-level or text clustering. In an example embodiment, the cluster processing step 309 may employ k-means clustering to use vector quantization for cluster analysis of the machine-annotated entity/relationship instances.

Once the machine-annotated entity/relationship instances (e.g., Eᵢ . . . Eₙ.) from the training and validation sets are assigned to the different groups or clusters (B₁ . . . B_{M}), the cognitive system processes the clustered entity/relationship instances at step 310 to generate a verification score for each annotation cluster based on one or more predetermined scoring features so as to identify clusters having candidate erroneous training examples for possible reclassification. The processing to generate verification scores for each may be performed at the low entropy training example prioritizer 19 (FIG. 1) or other NLP routine which is configured to prioritize clusters of phrases containing machine-annotated entity/relationship instances by scoring each machine-annotated ground-truth (MAGT) cluster according a set of verification metrics, producing a verification score for each MAGT cluster, and ranking the MAGT clusters according to the verification scores.

To exploit the efficiency of adding numerous MAGT instances from large clusters to the training set, the verification scoring at step 310 may use the size of the training example cluster as a scoring feature so that the largest clusters may receive the highest ranking verification score. In this way, larger sized clusters are prioritized for SME verification because, once verified, they contribute more to the training set size. The larger the cluster, the greater number of annotations that become verified by a human SME.

In addition or in the alternative, the verification scoring at step 310 may use a probability or confidence metric which quantifies the likelihood that annotations in a cluster are “true positives” based on the training model for the feature set of a given annotation cluster. In the context of aiding human verification of low-entropy annotations where annotations are clustered by feature similarity, the confidence metric may quantify the statistical probability (i.e., confidence score) that is computed by the underlying machine learning algorithm for the trained model for the feature set of a given annotation cluster. In selected embodiments, the confidence metric may be computed form the weighted average of the confidence scores for each annotation within a cluster, with lower confidence metric values indicating a greater need for human verification, especially over time as the training set expands and the accuracy of the training model improves.

In addition or in the alternative, the verification scoring at step 310 may use an SME consistency (or inconsistency) metric which quantifies the relative verification performance of the reviewing SME and other SMEs who have verified annotation instances within the same cluster. Of the potential set of annotation instances within a cluster that has been verified by other human SMEs, the SME consistency (or inconsistency) metric quantifies their disposition, depending on whether most of these annotations were verified as “true positive” or as “false positive” or some mixture of the two. If two human SMEs verified the same annotations instances within a cluster and their respective IAA scores indicate they were in agreement, the SME consistency metric can be used to leverage the verification results from other human SMEs on the project to try to get a sense of whether annotations within a cluster are more likely to be “true positive” or “false-positive.” If a training model is currently suffering from poor precision, clusters that are likely to constitute “false positive” training cases may want to be prioritized higher for SME verification review. If a training model is suffering from poor recall, “true positive” training cases might be a higher priority.

In addition or in the alternative, the verification scoring at step 310 may use a cross-validation accuracy score for each annotation in a cluster which quantifies how similar the features are for that particular annotation type. In the context of clustered low-entropy annotations where accuracy metrics within a cluster to have fairly high accuracy metrics (Recall/Precision/F1) amongst themselves (cross-validation), the cross-validation accuracy score of a given annotation within a cluster may quantify how similar the features are for that particular annotation type and cluster. If the annotation instances in a cluster are more similar to one another, the cross-validation accuracy score may be weighted to give the cluster a higher verification score since the SME may only need to review a few instances of an annotation for the given cluster. On the other hand, if there is greater variance between annotation instances within a cluster, the cross-validation accuracy score may be weighted to give the cluster a lower verification score since the SME probably needs to take a closer look and review more instances of an annotation before concluding their disposition on the cluster. Even though the annotation instances should be similar within these low entropy clusters, there are degrees of similarity therein and accuracy metrics from cross-validation of annotation instances within a cluster can be an indicator of how quickly a human SME can verify a cluster.

At step 322, the ground truth verification method provides a notification to the human SME of prioritized clusters with possible misclassification errors in the candidate erroneous training examples identified at step 321. The processing at step 322 may be performed at a cognitive system, such as the QA system 101, first computing system 14, or other NLP question answering system having a ground truth (GT) interface (e.g., 13) that can be configured to display clustered training examples that are flagged for SME validation. In selected embodiments, the notification processing at step 322 may begin at step 311 by visually presenting one or more training example clusters for SME review. The visual presentation of the training example clusters may flag candidate erroneous training examples within a cluster for possible reclassification by providing a cluster view of entity and/or relationship mentions from the training and validations sets, where each cluster is prioritized for display on the basis of the verification score computed at step 310. In addition, the visual presentation of the training example clusters may include verification suggestions for the human SME to identify training examples most likely to be misclassified or mislabeled, grouped by cluster, so that the human SME can quickly and efficiently identify training examples that are very likely false positives or negatives. The displayed verification suggestions may include verification options for removing individual labels, removing an entire cluster, and/or leaving the training set unchanged.

At step 312, the ground truth verification method updates and retrains the model based on the SME verification or correction input. The processing at step 312 may be performed at a cognitive system, such as the QA system 101, first computing system 14, or other NLP question answering system, which the proceeds to iteratively repeat the steps 305-312 until detecting at step 313 that the verification process is done. For example, if the detection step 313 determines that the machine-annotated entity/relationship instances have not all been verified and/or that the retrained model does not contain a good set of clustered training set examples with a low entropy score (negative outcome to detection step 313), the processing steps 305-312 are repeated to iteratively flag additional candidate erroneous training examples and update the training set. However, upon detecting that all machine-annotated entity/relationship instances have been verified by the SME and/or that the retrained model contains a good set of clustered training set examples with a low entropy score (affirmative outcome to detection step 313), the updated training set is applied to train the final annotator at step 314. For example, the SME-evaluated training set can be used as ground truth data to train QA systems, such as by presenting the ground truth data in the form of question-answer-passage (QAP) triplets or answer keys to a machine learning algorithm. Alternatively, the ground truth data can be used for blind testing by dividing the ground truth data into separate sets of questions and answers so that a first set of questions and answers is used to train a machine learning model by presenting the questions from the first set to the QA system, and then comparing the resulting answers to the answers from a second set of questions and answers.

After using the ground truth collection process 300 to identify, collect, and evaluate ground truth data, the process ends at step 315 until such time as the user reactivates the ground truth verification process 300 with another session. Alternatively, the ground truth verification process 300 may be reactivated by the QA system which monitors source documents to detect when updates are available. For example, when a new document version is available, the QA system may provide setup data to the ground truth collector engine 16 to prompt the user to re-validate the document for re-ingestion into the corpus if needed.

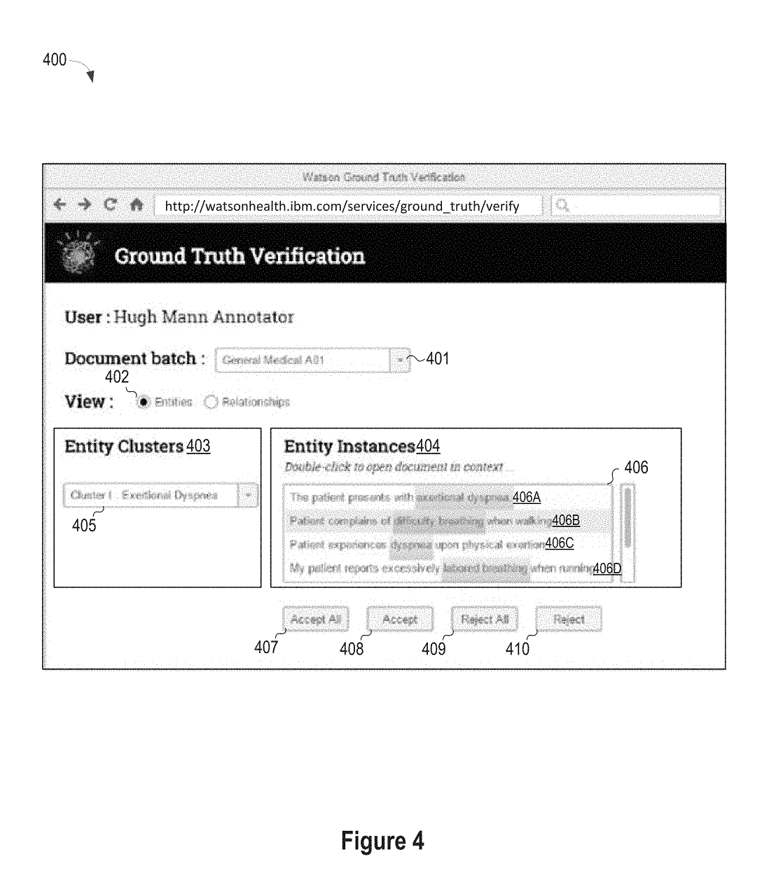

To illustrate additional details of selected embodiments of the present disclosure, reference is now made to FIG. 4 which illustrates an example ground truth verification interface display screen shot 400 with a clustered view of entity and/or relationship mentions 405-406 from machine-annotated training and validation sets for a selected cluster 405 used in connection with a browser-based ground truth data verification sequence. As indicated with the screen shot 400, a user (Hugh Mann Annotator) may access ground truth verification service (http://watsonhealth.ibm.com/services/ground_truth/verify) which displays information that may be used to create an annotator component by training the machine-learning annotator and evaluating how well the annotator performed when annotating test data and blind data. In the depicted screen shot 400, the user is processing a first document batch 401 (e.g., General Medical A01) with a displayed cluster view of entity mentions 405-406 in response to the user selecting or ticking the “Entities” option button 402. As will be appreciated, a cluster view of relationship mentions may be displayed in response to the user selecting or ticking the “Relationships” option button. Instead of displaying a flat list of entity/relationship mention instances for human verification, the background processing for the verification interface display screen 400 clusters similar entity/relationship mention instances and sorts the clusters based on a verification scoring mechanism which actively learns with each piece of input from the human annotation team to optimize the overall verification process by enabling batch verification of said clusters.

To organize the visual presentation of machine-annotated ground truth data for efficient verification, the verification interface display screen shot 400 may be configured to provide a clustered view of entity and/or relationship mentions 405-406 by using an “Entity Cluster” viewing window or area 403 and an “Entity Instances” viewing window or area 404. Under the “Entity Cluster” viewing window/area 403, an entity cluster field 405 identifies a first prioritized entity cluster (e.g., “Exertional Dyspnea”) that was selected or flagged on the basis of having the highest cluster verification score. In selected embodiments, the entity cluster field 405 may list a plurality of ranked entity clusters in a drop-down menu that are ranked by descending cluster verification score. Under the “Entity Instances” viewing window/area 404, the entity instances 406A-D corresponding to the first prioritized entity cluster 405 are listed for review, correction and verification by the user. As disclosed herein, the entity instances 406A-D in each entity group (e.g., 405) may be generated using any suitable vector formation and clustering technique to represent each training/validation set phrase in vector form and then determine a similarity or grouping of different vectors, such as by using a neural network language model representation techniques (e.g., Word2Vec, Doc2Vec, or similar tool) to convert words and phrases to vectors which are then input to a clustering algorithm to place words and phrases with similar meanings close to each other in a Euclidean space. Through user interaction with one or more control buttons 407-410, the user has the option to accept or reject the listed entity instances 406 for the first prioritized entity cluster 405. For example, the user can click on a suggestion to see the entire document (through cursor interaction with a selected training example), accept an entire cluster of entity instances (with button 407), accept or verify individual entity instances (with button 408), reject an entire cluster of entity instances (with button 409), or reject individual entity instances (with button 410). Once the entity instances 406A-D for the review candidate training examples in the “Entity Instances” viewing window/area 404 are corrected or verified by the SME, the training set is updated to retrain the classifier or annotator model, and the ground truth data verification sequence is iteratively repeated until an evaluation of the training set annotations indicates that the required accuracy is obtained.

By now, it will be appreciated that there is disclosed herein a system, method, apparatus, and computer program product for verifying ground truth data at an information handling system having a processor and a memory. As disclosed, the system, method, apparatus, and computer program product receive ground truth data which includes a small human-curated training set. Using an annotator, such as a dictionary annotator, rule-based annotator, or a machine learning annotator, annotation operations are performed on the training set to generate a machine-annotated training set. Subsequently, examples from the machine-annotated training set are assigned to one or more clusters using a cluster model according to a feature vector similarity measure, such as by generating a vector representation for each of example from the machine-annotated training set, and then applying one or more feature selection algorithms to the vector representations of the machine-annotated training set examples to identify the one or more clusters. The information handling system may then use a natural language processing (NLP) computer system to analyze one or more clusters to prioritize clusters based on verification scores computed for each cluster. In selected embodiments, the verification score for each cluster is computed as a confidence metric which quantifies how likely that annotations in the cluster are true positives based on a training model for the feature set of a given annotation cluster. In other embodiments, the verification score for each cluster is computed as an Inter Annotator Agreement (IAA) score measuring how consistent annotations of the human SME are with annotations from a group of human SMEs for a given annotation cluster. In other embodiments, the verification score for each cluster is computed as a cluster size score measuring a given annotation cluster. In other embodiments, the verification score for each cluster is computed as a cross-validation score measuring how similar the machine-annotated training set examples are to a feature set for a given annotation cluster. Once identified, the machine-annotated training set examples associated with a prioritized cluster are displayed as prioritized review candidates to solicit verification or correction feedback from a human subject matter expert (SME) for inclusion in an accepted training set. In selected embodiments, the prioritized review candidates in a cluster may be verified or corrected together as a single group based on verification or correction feedback from the human subject matter expert. In other embodiments, the prioritized review candidates in a cluster may be verified or corrected individually based on verification or correction feedback from the human subject matter expert. Through an iterative process of repeating the foregoing steps, the accepted training set may be used to train a final annotator.

While particular embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of verifying ground truth data, the method comprising:
receiving, by an information handling system, comprising a processor and a memory, ground truth data comprising a human-curated training set;
performing, by the information handling system, annotation operations on the training set using an annotator to generate a machine-annotated training set;
assigning, by the information handling system, examples from the machine-annotated training set to one or more clusters according to a feature vector similarity measure;
analyzing, by the information handling system, the one or more clusters to prioritize clusters based on verification scores computed for each cluster; and
displaying, by the information handling system, machine-annotated training set examples associated with a prioritized cluster as prioritized review candidates to solicit verification or correction feedback from a human subject matter expert (SME) for inclusion in an accepted training set.

2. The method of claim 1, where the annotator comprises a dictionary annotator, rule-based annotator, or a machine learning annotator.

3. The method of claim 1, where assigning examples from the machine-annotated training set to one or more clusters comprises:
generating a vector representation for each of example from the machine-annotated training set; and
applying one or more feature selection algorithms to the vector representations of the machine-annotated training set examples to identify the one or more clusters.

4. The method of claim 1, where analyzing the one or more clusters comprises computing a verification score for each cluster as a confidence metric which quantifies how likely that annotations in the cluster are true positives based on a training model for the feature set of a given annotation cluster.

5. The method of claim 1, where analyzing the one or more clusters comprises computing a verification score for each cluster as an Inter Annotator Agreement (IAA) score measuring how consistent annotations of the human SME are with annotations from a group of human SMEs for a given annotation cluster.

6. The method of claim 1, where analyzing the one or more clusters comprises computing a verification score for each cluster as a cluster size score measuring a given annotation cluster.

7. The method of claim 1, where analyzing the one or more clusters comprises computing a verification score for each cluster as a cross-validation score measuring how similar the machine-annotated training set examples are to a feature set for a given annotation cluster.

8. The method of claim 1, further comprising verifying or correcting all prioritized review candidates in a cluster as a single group based on verification or correction feedback from the human subject matter expert.

9. A computer program product comprising a computer readable storage medium having a computer readable program stored therein, wherein the computer readable program, when executed on an information handling system, causes the system to verify ground truth data by:
receiving ground truth data comprising a human-curated training set;
performing annotation operations on the training set using an annotator to generate a machine-annotated training set;
assigning examples from the machine-annotated training set to one or more clusters according to a feature vector similarity measure;
analyzing the one or more clusters to prioritize clusters based on verification scores computed for each cluster; and
displaying machine-annotated training set examples associated with a prioritized cluster as prioritized review candidates to solicit verification or correction feedback from a human subject matter expert (SME) for inclusion in an accepted training set.

10. The computer program product of claim 9, wherein the computer readable program, when executed on the system, causes the system to perform annotation operations using a dictionary annotator, rule-based annotator, or a machine learning annotator.

11. The computer program product of claim 9, wherein the computer readable program, when executed on the system, causes the system to assign examples from the machine-annotated training set to one or more clusters by:
generating a vector representation for each of example from the machine-annotated training set; and
applying one or more feature selection algorithms to the vector representations of the machine-annotated training set examples to identify the one or more clusters.

12. The computer program product of claim 9, wherein the computer readable program, when executed on the system, causes the system to analyze the one or more clusters by computing a verification score for each cluster as a confidence metric which quantifies how likely that annotations in the cluster are true positives based on a training model for the feature set of a given annotation cluster.

13. The computer program product of claim 9, wherein the computer readable program, when executed on the system, causes the system to analyze the one or more clusters by computing a verification score for each cluster as an Inter Annotator Agreement (IAA) score measuring how consistent annotations of the human SME are with annotations from a group of human SMEs for a given annotation cluster.

14. The computer program product of claim 9, wherein the computer readable program, when executed on the system, causes the system to analyze the one or more clusters by computing a verification score for each cluster as a cluster size score measuring a given annotation cluster.

15. The computer program product of claim 9, wherein the computer readable program, when executed on the system, causes the system to analyze the one or more clusters by computing a verification score for each cluster as a cross-validation score measuring how similar the machine-annotated training set examples are to a feature set for a given annotation cluster.

16. The computer program product of claim 9, further comprising computer readable program, when executed on the system, causes the system to verify or correct all prioritized review candidates in a cluster as a single group based on verification or correction feedback from the human subject matter expert.

17. An information handling system comprising:
one or more processors;
a memory coupled to at least one of the processors; and
a set of instructions stored in the memory and executed by at least one of the processors to verify ground truth data, wherein the set of instructions are executable to perform actions of:
receiving, by the system, ground truth data comprising a human-curated training set;
perforating, by the system, annotation operations on the training set using an annotator to generate a machine-annotated training set;
assigning, by the system, examples from the machine-annotated training set to one or more clusters according to a feature vector similarity measure;
analyzing, by the system, the one or more clusters to prioritize clusters based on verification scores computed for each cluster; and
displaying, by the system, machine-annotated training set examples associated with a prioritized cluster as prioritized review candidates to solicit verification or correction feedback from a human subject matter expert (SME) for inclusion in an accepted training set.

18. The information handling system of claim 17, where analyzing the one or more clusters comprises computing a verification score for each cluster as a confidence metric which quantifies how likely that annotations in the cluster are true positives based on a training model for the feature set of a given annotation cluster.

19. The information handling system of claim 17, where analyzing the one or more clusters comprises computing a verification score for each cluster as an Inter Annotator Agreement (IAA) score measuring how consistent annotations of the human SME are with annotations from a group of human SMEs for a given annotation cluster.

20. The information handling system of claim 17, where analyzing the one or more clusters comprises computing a verification score for each cluster as a cluster size score measuring a given annotation cluster.

21. The information handling system of claim 17, where analyzing the one or more clusters comprises computing a verification score for each cluster as a cross-validation score measuring how similar the machine-annotated training set examples are to a feature set for a given annotation cluster.

22. The information handling system of claim 17, further comprising verifying or correcting all prioritized review candidates in a cluster as a single group based on verification or correction feedback from the human subject matter expert.

23. The information handling system of claim 17, further comprising verifying or correcting prioritized review candidates in a cluster one at a time based on verification or correction feedback from the human subject matter expert.
